(19) United States
(12) Patent Application Publication
(10) Pub. No.: US 2005/0100187 A1
(43) Pub. Date: May 12, 2005

(54) Speaker box mounting structure

(75) Inventor: Tony Yang, Taichung (TW)

Correspondence Address: BACON & THOMAS, PLLC, 625 SLATERS LANE, FOURTH FLOOR, ALEXANDRIA, VA, 22314, US

(73) Assignee: SEKAKU ELECTRON INDUSTRY CO., LTD., TAICHUNG (TW)

(21) Appl. No.: 10/701,477

(22) Filed: Nov. 6, 2003

(51) Int. Cl. H04R 1/02

(52) U.S. Cl. 381/386; 381/387; 381/390; 381/395

(57) ABSTRACT

A speaker box mounting structure includes a holder base having a mounting plate for fastening to a wall or ceiling, a swivel arm set coupled to the holder base and adjustable relative to the holder base to a desired direction and angle, a coupling unit coupled to the swivel arm set, the coupling unit having a base, a coupling portion disposed at the base, and two stop faces disposed at two sides of the coupling portion and defining a contained angle, and a speaker box having a coupling portion coupled to the coupling portion of the coupling unit, and two stop faces disposed at two sides and respectively stopped against the stop faces of the coupling unit.

### BACKGROUND OF THE INVENTION

1. Field of the Invention

The present invention relates generally to speakers and, more specifically, to a speaker box mounting structure for a speaker system.

2. Description of the Related Art

A conventional speaker support is known comprising a first swivel arm that can be turned relative to the mounting wall to which the speaker support is fastened, a second swivel arm that couples the speaker box to the first swivel arm for enabling the speaker box to be turned relative to the first swivel arm to the desired angle, and lock screws for locking the first swivel arm to the mounting wall and the second swivel arm to the first swivel arm respectively. This design of speaker box mounting structure is complicated. It is also complicated to adjust the angular position of the speaker box relative to the first swivel arm and the angular position of the first swivel arm relative to the mounting wall. Further, the speaker box must be locked to the second swivel arm of the support by screws or other fastening devices that may obstruct the structural strength of the speaker box.

Therefore, it is desirable to provide a speaker box mounting structure that eliminates the aforesaid drawbacks.

### SUMMARY OF THE INVENTION

The present invention has been accomplished under the circumstances in view. It is the main object of the present invention to provide a speaker box mounting structure, which enables the speaker box to be quickly and positively set in position and conveniently adjusted to the desired angle.

It is another object of the present invention to provide a speaker box mounting structure, which is easy to install.

To achieve these objects of the present invention, the speaker box mounting structure comprises a holder base having a mounting plate for fastening to a wall or ceiling; a swivel arm set coupled to the holder base and adjustable relative to the holder base to a desired direction and angle; a coupling unit coupled to the swivel arm set, the coupling unit having a base, a coupling portion disposed at the base of the coupling unit, and two stop faces disposed at two sides of the coupling portion of the coupling unit and defining a contained angle; and a speaker box having a coupling portion coupled to the coupling portion of the coupling unit, and two stop faces disposed at two sides of the coupling portion of the speaker box and respectively stopped against the stop faces of the coupling unit.

### BRIEF DESCRIPTION OF THE DRAWINGS

FIG. 1 is an exploded view of a speaker box mounting structure according to the present invention.

FIG. 2 is a front plain assembly view of the speaker box mounting structure according to the present invention.

FIG. 3 is a top plain assembly view of the speaker box mounting structure according to the present invention.

FIG. 4 is similar to FIG. 2 but showing the angular position of the second swivel arm adjusted relative to the first swivel arm.

FIG. 5 is a top plain view of FIG. 4.

FIGS. 6(a)˜6(d) are schematic drawings showing different speaker box position adjustment examples.

FIG. 7 is an exploded plain view of a part of the present invention showing the coupling arrangement between the coupling unit and the speaker box according to the present invention.

FIG. 8 is an exploded plain view showing an alternate form of the coupling arrangement between the coupling unit and the speaker box according to the present invention.

FIG. 9 is an exploded plain view showing another alternate form of the coupling arrangement between the coupling unit and the speaker box according to the present invention.

FIG. 10 is an exploded plain view showing still another alternate form of the coupling arrangement between the coupling unit and the speaker box according to the present invention.

FIG. 11 is an exploded plain view showing still another alternate form of the coupling arrangement between the coupling unit and the speaker box according to the present invention.

FIG. 12 is an exploded plain view showing still another alternate form of the coupling arrangement between the coupling unit and the speaker box according to the present invention.

FIG. 13 is an exploded view showing the first coupling portion and second coupling portion of the coupling unit arranged at right angles according to the present invention.

### DETAILED DESCRIPTION OF THE INVENTION

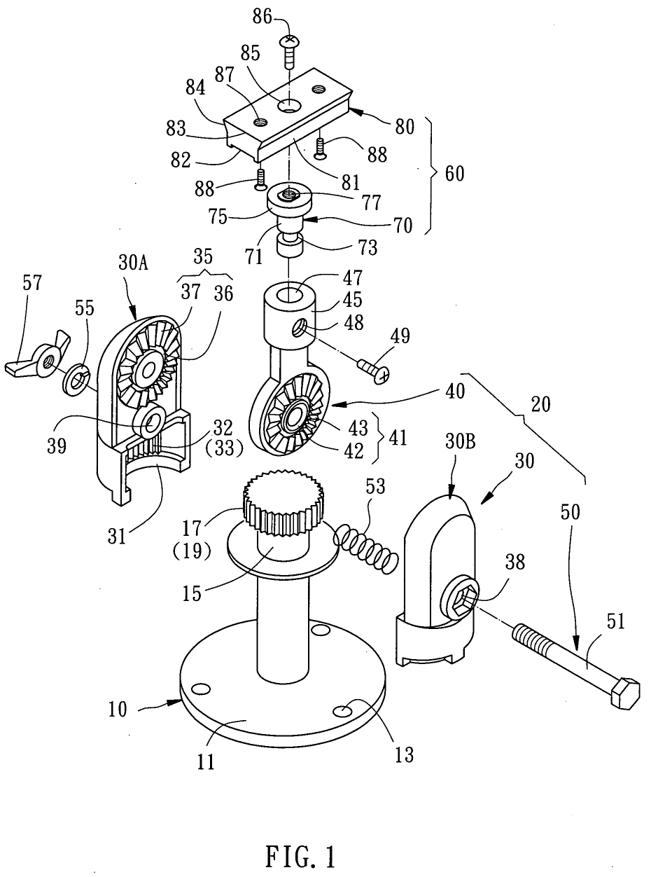

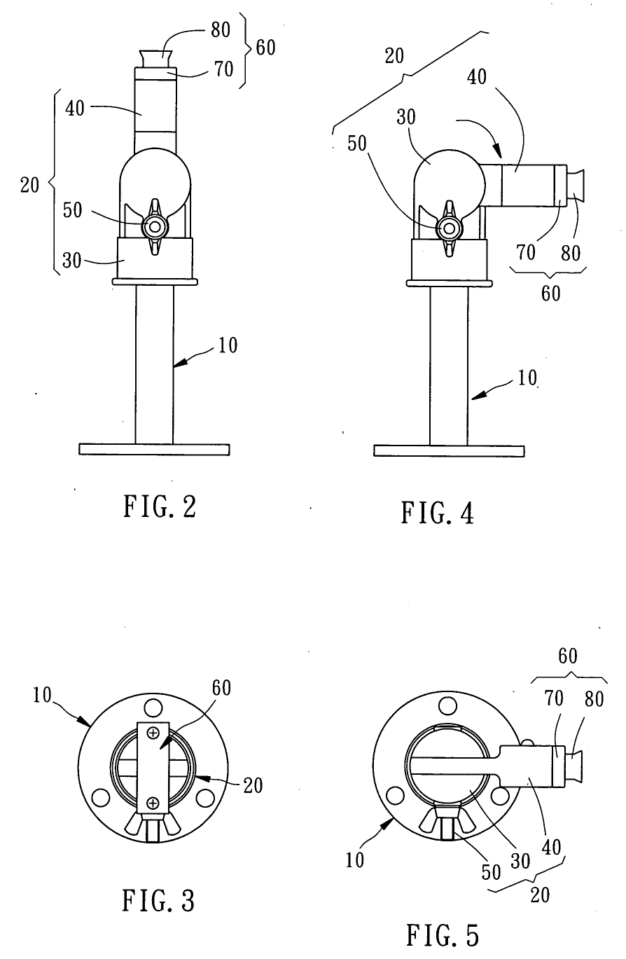

Referring to FIGS. 1˜7, a speaker box mounting structure in accordance with the present invention is shown comprised of a holder base 10, a swivel arm set 20, a coupling unit 60, and a speaker box 90.

The holder base 10 comprises a mounting plate 11, which has a plurality of mounting holes 13 for fastening to the wall or ceiling with screws, a rod-like neck 15 disposed at the center of the mounting plate 11, and an engagement member 17 disposed at the distal end of the neck 15 remote from the mounting plate 11. The diameter of the engagement member 17 is greater than the neck 15. Further, the engagement member 17 has a toothed portion 19 around the periphery.

The swivel arm set 20 is comprised of a first swivel arm 30, a second swivel arm 40, and a lock 50.

The first swivel arm is comprised of a first clamping member 30A and a second clamping member 30B. The first clamping member 30A comprises a recessed coupling portion 31 disposed at one end and adapted to receive the neck 15 of the holder base 10, a first engagement structure 32 disposed above the recessed coupling portion 31 and adapted to engage the engagement member 17 of the holder base 10, the first engagement structure 32 having a toothed portion 33 for engagement with the toothed portion 19 of the first engagement member 32, a second engagement structure 35 disposed at the other end, the second engagement structure 35 comprising an annular coupling groove 36 and radial teeth 37 around the annular coupling groove 36, and a through hole 39 transversely extended through two opposite sides between the first engagement structure 32 and the second engagement structure 35. The second clamping member 30B is substantially similar to the first clamping member 30A with the exception of an added receptacle 38 at the outer end of the through hole 39.

The second swivel arm 40 comprises an engagement structure 41 disposed at one end, the engagement structure 41 comprising an annular coupling flange 42 and radial teeth 43 at each of the two opposite sides corresponding to the annular coupling groove 36 and radial teeth 37 of the second engagement structure 35 of each of the clamping members 30A and 30B of the first swivel arm 30, a locating head 45 disposed at the other end, a plug hole 47 axially extended through the head 45, and a transverse screw hole 48 disposed at the head 45 in communication with the plug hole 47 for receiving a tightening up screw 49.

The lock 50 comprises a screw bolt 51 inserted through the through holes 39 of the clamping members 30A and 30B of the first swivel arm 30, a compression spring 53 sleeved onto the screw bolt 51 and stopped between the clamping members 30A and 30B of the first swivel arm 30, a wing nut 57 threaded onto the screw bolt 51 to secure the screw bolt 51 to the first swivel arm 30, and a washer 55 sleeved onto the screw bolt 51 and stopped between the wing nut 57 and the first clamping member 30A.

The coupling unit 60 is comprised of a coupling rod 70 and a coupling block 80.

The coupling rod 70 comprises a shank 71 inserted into the plug hole 47 of the second swivel arm 40, a locating groove 73 extended around the periphery of the shank 71 and adapted to receive the tightening up screw 49, a locating head 75 disposed at one end of the shank 71, and a screw hole 77 axially disposed at the locating head 75.

The coupling block 80 comprises a base 81, a locating groove 82 disposed at the base 81, a coupling portion, for example, a dovetail tongue 83 disposed at the base 81, two stop faces 84 disposed at two sides of the dovetail tongue 83 and defining a contained angle, a mounting hole 85 extended through the base 81 and connected to the screw hole 77 of the coupling rod 70 by a screw 86, and two screw holes 87 extended through the base 81 at two sides of the mounting hole 85 and adapted to receive a respective screw 88.

The speaker box 90 comprises a coupling portion, for example, a dovetail groove 93 adapted to receive the dovetail tongue 83 of the coupling block 80, and two stop faces 94 disposed at two sides of the dovetail groove 93 and adapted to stop against the stop faces 84 of the coupling block 80 respectively.

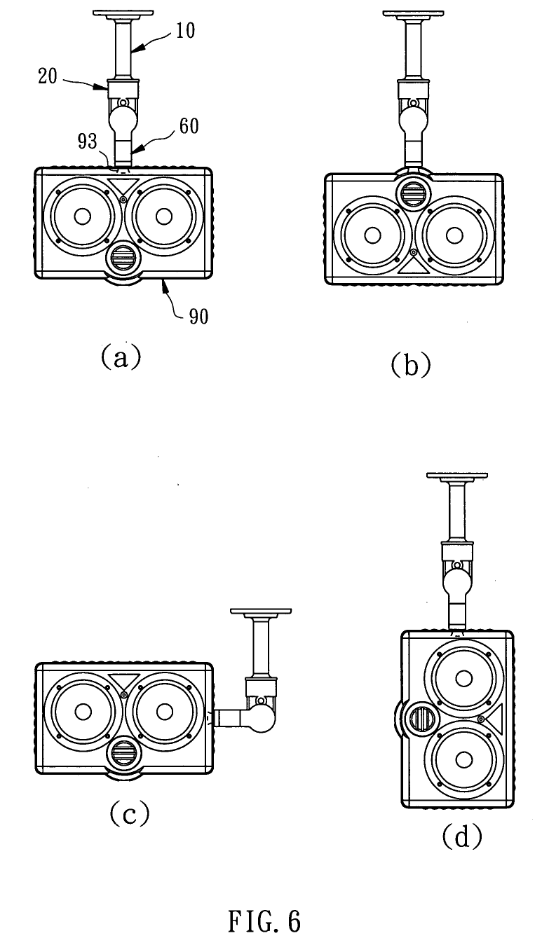

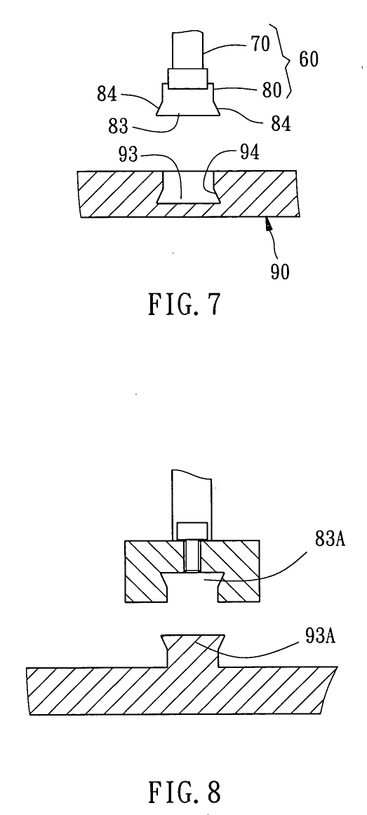

Referring to FIGS. 4˜6 again, when loosened the lock 50, the second swivel arm 40 is turned relative to the first swivel arm 30 to the desired angle, and then the lock 50 is fastened up to lock the second swivel arm 40 to the first swivel arm 30 again. As shown in FIGS. 6(a)˜6(d), by means of the speaker box mounting structure of the present invention, the speaker box 90 can be adjusted to any of various positions.

In additional to the aforesaid preferred embodiment of the present invention, various modifications and changes could be made thereunto without departing from the spirit and scope of the invention. Some modified examples of the present invention are outlined hereinafter.

As shown in FIG. 8, the coupling portion 83A of the coupling block is a dovetail groove, and the coupling portion 93A of the speaker box is a dovetail tongue adapted to engage the dovetail groove 83A.

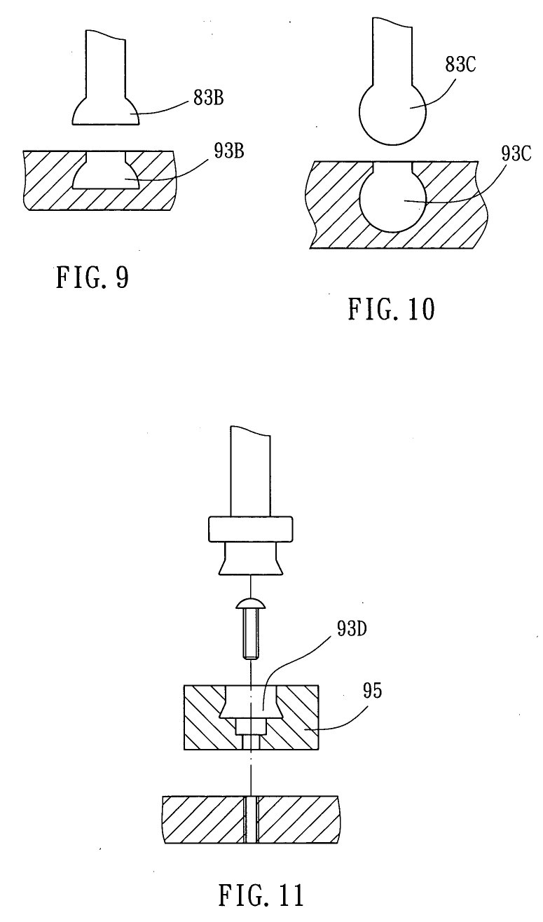

As shown in FIG. 9, the coupling portion 83B of the coupling block is a semispherical tongue, and the coupling portion 93B of the speaker box is a semispherical groove adapted to receive the semispherical tongue 83B.

As shown in FIG. 10, the coupling portion 83C of the coupling block is a ball head, and the coupling portion 93C of the speaker box is a ball socket adapted to receive the ball head 83B.

As shown in FIG. 11, the coupling portion 93D of the speaker box is formed in a mounting block detachably fastened to the speaker box.

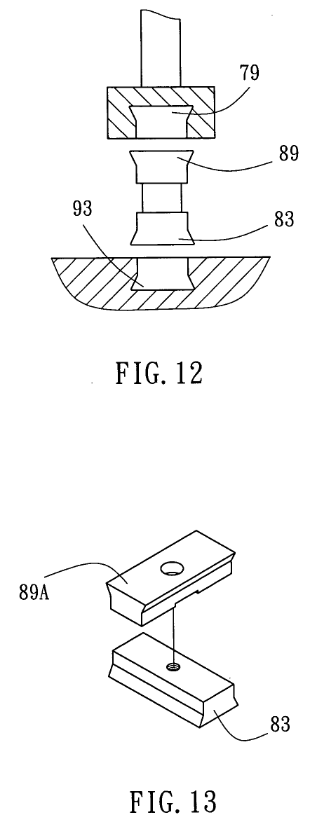

As shown in FIG. 12, in addition to the coupling portion 83 for coupling to the coupling portion 93 of the speaker box, the coupling block further comprises a second coupling portion 89, which is a dovetail tongue disposed in parallel to the coupling portion 83 and adapted to engage a dovetail groove 79 at the coupling rod of the coupling unit.

As shown in FIG. 13, the second coupling portion 89A of the coupling block of the aforesaid coupling unit and the coupling portion 83 are arranged at right angles.

As indicated above, the invention has the following advantages:

1. The speaker box mounting structure enables the speaker box to be quickly and positively set in position and conveniently adjusted to the desired angle.

2. The speaker box mounting structure is easy to install.

1. A speaker box mounting structure comprising:
a holder base having a mounting plate for fastening to a wall or ceiling;
a swivel arm set coupled to said holder base and adjustable relative to said holder base to a desired direction and angle;
a coupling unit coupled to said swivel arm set, said coupling unit having a base, a coupling portion disposed at the base of said coupling unit, and two stop faces disposed at two sides of the coupling portion of said coupling unit and defining a contained angle; and
a speaker box having a coupling portion coupled to the coupling portion of said coupling unit, and two stop faces disposed at two sides of the coupling portion of said speaker box and respectively stopped against the stop faces of said coupling unit.

2. The speaker box mounting structure as claimed in claim 1, wherein said swivel arm set comprises a first swivel arm coupled to said bolder base, and a second swivel arm coupled between said first swivel arm and said coupling unit and adapted to adjust the angular position of said coupling unit relative to said first swivel arm.

3. The speaker box mounting structure as claimed in claim 1, wherein the coupling portion of said coupling unit is a coupling block, and the coupling portion of said speaker box is a coupling groove for receiving said coupling block.

4. The speaker box mounting structure as claimed in claim 1, wherein coupling portion of said coupling unit is a coupling groove, and the coupling portion of said speaker box is a coupling block engaged into said coupling groove of said coupling portion of said coupling unit.

5. The speaker box mounting structure as claimed in claim 1, wherein said coupling unit further comprises a coupling rod coupled between said base and said swivel arm set.

6. The speaker box mounting structure as claimed in claim 1, wherein the coupling portion of said coupling unit and the coupling portion of said speaker box have a shape selected from the group consisting of dovetailed shape, semispherical shape, cylindrical shape, and spherical shape.

7. The speaker box mounting structure as claimed in claim 1, wherein said coupling unit further comprises a coupling rod coupled between said base and said swivel arm set, and a coupling block for securing said speaker box to said coupling rod, said coupling block forming the base, coupling portion and stop faces of said coupling unit.

8. The speaker box mounting structure as claimed in claim 7, wherein the coupling block of said coupling unit further comprises a second coupling portion, and said coupling rod has a coupling portion connected to the second coupling portion of the coupling block of said coupling unit.

9. The speaker box mounting structure as claimed in claim 1, wherein said holder base comprises an engagement device; said swivel arm set comprises a first swivel arm, an engagement device formed integral with said first swivel arm and engaged with the engagement device of said holder base.

10. The speaker box mounting structure as claimed in claim 9, wherein said swivel arm set further comprises a second swivel arm having an engagement device, said first swivel arm of said swivel arm set further comprises a second engagement device engaged with said engagement device of said second swivel arm at a desired angle.
